(19) United States
(12) Patent Application Publication
(10) Pub. No.: US 2017/0056143 A1
(43) Pub. Date: Mar. 2, 2017

(54) APPARATUS FOR CLEANING ORAL CAVITY

(71) Applicant: Ki Bong HYUN, Yongsan-gu, Seoul (KR)

(72) Inventor: Ki Bong HYUN, Yongsan-gu, Seoul (KR)

(21) Appl. No.: 15/120,181

(22) PCT Filed: Feb. 13, 2015
(86) PCT No.: PCT/KR2015/001458

§ 371 Date: Aug. 19, 2016

(30) Foreign Application Priority Data
Feb. 21, 2014 (KR) 10-2014-0020536

(51) Int. Cl. A61C 17/02; A61C 17/028

(52) U.S. Cl. CPC A61C 17/0208; A61C 17/0211; A61C 17/028

(57) ABSTRACT

An apparatus for cleaning the oral cavity comprises: a body including insertion slots into which the teeth of a user can be inserted, a plurality of injection holes and a plurality of aspiration holes formed on the inner wall of the insertion slots; a feeding tube for supplying cleaning liquid to the plurality of injection holes; a discharge tube through which the cleaning liquid is externally discharged via the plurality of aspiration holes; and a switching member for switching the direction of injection and the direction of aspiration of the cleaning liquid, wherein the body includes a first inner space which communicates with the plurality of injection holes, and a second inner space which communicates with the plurality of aspiration holes.

### TECHNICAL FIELD

The present disclosure relates to an oral cavity cleaning apparatus.

### BACKGROUND ART

Food waste present in teeth or an oral cavity may be decomposed with the passage of time to cause bad breath or cause various oral diseases such as tooth decay or gum disease. In order to maintain healthy teeth and a healthy oral cavity, individuals are required to continually clean their oral cavity by frequently brushing teeth or gargling with mouthwash, or the like.

In general, in order to clean teeth, an individual may use a toothbrush and dental floss. However, it may be difficult to completely remove food waste stuck between the user's teeth through methods using only a toothbrush and dental floss, and immoderate use of a toothbrush and dental floss may damage an individual's gums or periodontal tissue.

Thus, recently, an oral cavity cleaning apparatus having various structures for cleaning an oral cavity by jetting cleaning liquid have been proposed. A related art oral cavity cleaning apparatus removes foreign objects stuck in an oral cavity or between teeth by jetting liquid or a bactericidal cleaning liquid, and includes a container accommodating a cleaning liquid, an injection nozzle, and a pump supplying the cleaning liquid in the container to the injection nozzle.

However, since the related art oral cavity cleaning apparatus is configured to jet a cleaning liquid through the injection nozzle, the cleaning liquid may splash out of the oral cavity, and thus, the related art oral cavity cleaning apparatus may only be used only in a restricted area such as a bathroom, or the like. Here, the user may close his or her mouth so as to stop the cleaning liquid from splashing out, but, in this case, cleaning liquid having cleaned the oral cavity may remain within the oral cavity so that the cleaning liquid should periodically be spat out. Also, in the related art oral cavity cleaning apparatus, cleaning liquid may be accumulated within the oral cavity during a cleaning process, making it difficult to clean the oral cavity over a relatively long period of time.

Also, when an oral cavity is cleaned using the related art oral cavity cleaning apparatus, food waste stuck between teeth may be removed from locations between the teeth but not automatically discharged outwardly, causing user inconvenience.

### DISCLOSURE

### Technical Problem

Therefore, an aspect of the present disclosure relates to removing food waste from teeth and gums.

Another aspect of the present disclosure is to simply clean teeth and an oral cavity, while reducing a phenomenon in which a cleaning liquid splashes outwardly thereof, without restricting a usage location.

Another aspect of the present disclosure is to effectively clean food waste from teeth and gums.

Exemplary embodiments of the present invention may also be used to achieve other technical solutions, not specifically mentioned, in addition to the foregoing technical solution.

### Technical Solution

According to an aspect of the present disclosure, an oral cavity cleaning apparatus may include: a body including an insertion slot into which a user's teeth are inserted and a plurality of injection holes and a plurality of suction holes positioned in an inner wall of the insertion slot; a liquid supply tube supplying a cleaning liquid through the plurality of injection holes; a liquid drain tube discharging the cleaning liquid outwardly through the plurality of suction holes; and a switching member switching an injection direction and a suction direction of the cleaning liquid, wherein the body includes a first internal space communicating with the plurality of injection holes and a second internal space communicating with the plurality of suction holes.

The oral cavity cleaning apparatus may further include: a sealing member protruding from an edge of an ingress of the insertion slot and tightly attached to the user's gums.

The liquid supply tube may include a first liquid supply tube and a second liquid supply tube, the liquid drain tube may include a first liquid drain tube and a second liquid drain tube, and the switching member may selectively open and close the first liquid supply tube and the first liquid drain tube or the second liquid supply tube and the second liquid drain tube.

The switching member may be positioned between the liquid supply tube and the liquid drain tube, respectively, and a supply tube and a discharge tube, respectively, and open the first liquid supply tube and the first liquid drain tube, and close the second liquid supply tube and the second liquid drain tube, or may open the second liquid supply tube and the second liquid drain tube, and close the first liquid supply tube and the first liquid drain tube.

The switching member may rotate around a rotational axis thereof and have a pair of flow path holes provided in locations facing each other while being centered on the rotational axis to open the first liquid supply tube and the first liquid drain tube and close the second liquid supply tube and the second liquid drain tube or to open the second liquid supply tube and the second liquid drain tube and close the first liquid supply tube and the first liquid drain tube.

The plurality of injection holes may be positioned in any one of the side of an inner wall of the insertion slot corresponding to an outer surface of teeth and the side of the inner wall of the insertion slot corresponding to an inner surface of the teeth, and the plurality of suction holes may be positioned in the other of the side of the inner wall of the insertion slot corresponding to the outer surface of the teeth and the side of the inner wall of the insertion slot corresponding to the inner surface of the teeth.

The plurality of injection holes may be positioned in the side of the inner wall of the insertion slot corresponding to the outer surface of the teeth and on the side of the inner wall of the insertion slot corresponding to the inner surface of the teeth, and the plurality of suction holes may be positioned in a bottom surface of the insertion slot.

The oral cavity cleaning apparatus may further include an elastic member positioned on the bottom surface of the insertion slot.

The oral cavity cleaning apparatus may further include: a first connector installed at an outer end of each of the liquid supply tube and the liquid drain tube; a second connector detachably coupled to the first connector; a supply tube installed in the second connector in one end thereof and communicating with the liquid supply tube; and a discharge tube installed in the second connector in one end thereof and communicating with the liquid drain tube.

The cleaning liquid supplied through the liquid supply tube may include bubbles.

The oral cavity cleaning apparatus may further include: a plurality of flow members attached to an inner wall of the insertion slot and extending toward the user's teeth.

The insertion slot may include: an upper insertion slot into which the user's upper teeth are inserted and a lower insertion slot into which the user's lower teeth are inserted.

The oral cavity cleaning apparatus may further include: a pressure sensor installed on a bottom surface of the insertion slot, measuring an amount of pressure by which the user holds the body and generating a corresponding signal; and an air compressor generating vacuum pressure in an internal flow channel of the liquid drain tube and increasing or decreasing a magnitude of the vacuum pressure according to the signal generated by the pressure sensor.

### Advantageous Effects

According to exemplary embodiments of the present disclosure, food waste of teeth and gums may be removed, teeth and an oral cavity may be simply cleaned, while a phenomenon in which a cleaning liquid splashes outwardly is reduced and a usage location is not limited, and food waste of teeth and gums may be effectively cleaned.

### DESCRIPTION OF DRAWINGS

FIG. 1 is a perspective view of an oral cavity cleaning apparatus according to an exemplary embodiment.

FIG. 2 is a front view of an oral cavity cleaning apparatus according to an exemplary embodiment.

FIG. 3 is a plan cross-sectional view of an oral cavity cleaning apparatus according to an exemplary embodiment.

FIG. 4 is a side view of an oral cavity cleaning apparatus according to an exemplary embodiment.

FIG. 5 is a cross-sectional view of a portion of an oral cavity cleaning apparatus according to an exemplary embodiment into which front teeth are inserted.

FIG. 6 is a cross-sectional view of a portion of an oral cavity cleaning apparatus according to an exemplary embodiment into which back teeth are inserted.

FIG. 7 is a cross-sectional view of a portion of an oral cavity cleaning apparatus according to an exemplary embodiment into which back teeth are inserted.

FIG. 8 is a partial cross-sectional view of a portion of an oral cavity cleaning apparatus according to an exemplary embodiment into which back teeth are inserted.

FIG. 9 is a schematic view of an oral cavity cleaning apparatus according to an exemplary embodiment.

FIG. 10 is a perspective view of an oral cavity cleaning apparatus according to an exemplary embodiment.

FIG. 11 is a plan cross-sectional view of an oral cavity cleaning apparatus according to an exemplary embodiment.

FIG. 12 is a cross-sectional view of a dead central portion of an oral cavity cleaning apparatus according to an exemplary embodiment into which front teeth are inserted.

### BEST MODE FOR INVENTION

Hereinafter, exemplary embodiments will be described in detail with reference to the accompanying tables and drawings such that they could be easily practiced by those skilled in the art to which the present invention pertains.

As those skilled in the art will realize, the described exemplary embodiments may be modified in various different ways, all without departing from the spirit or scope of the present invention. In the accompanying drawings, portion irrelevant to descriptions of the present invention will be omitted for clarity, and like reference numerals refer to like elements throughout. Also, detailed descriptions of a known art will be omitted.

Throughout the specification, unless explicitly described to the contrary, the word “comprise” and variations such as “comprises” or “comprising”, will be understood to imply the inclusion of stated elements but not the exclusion of any other elements.

Hereinafter, an oral cavity cleaning apparatus according to an exemplary embodiment will be described in detail with reference to the accompanying drawings.

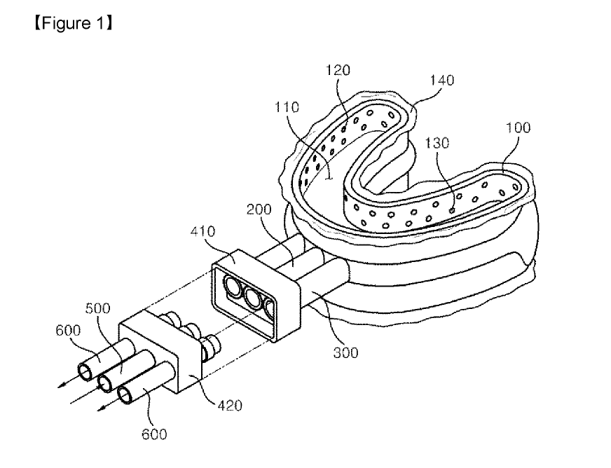

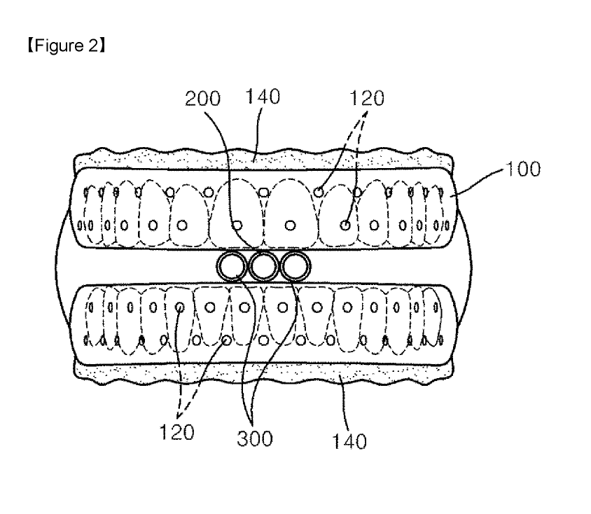

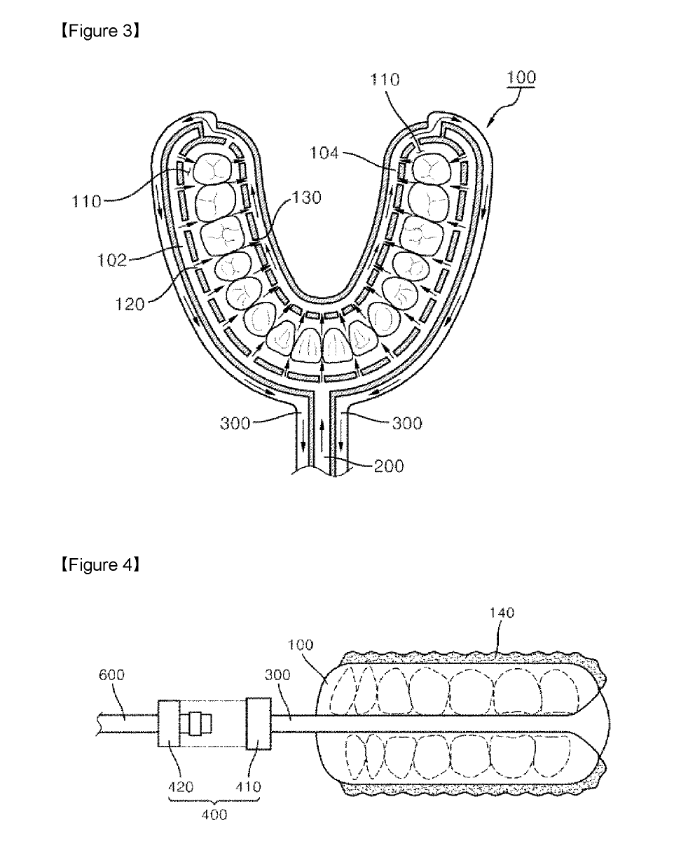

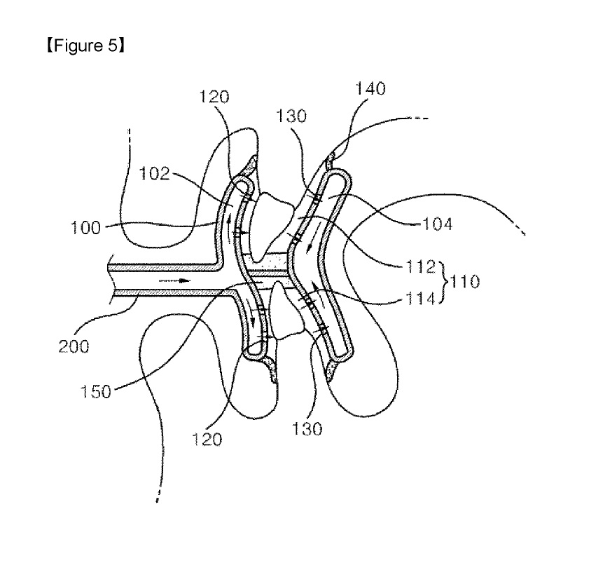

FIG. 1 is a perspective view of an oral cavity cleaning apparatus according to an exemplary embodiment, FIG. 2 is a front view of an oral cavity cleaning apparatus according to an exemplary embodiment, FIG. 3 is a plan cross-sectional view of an oral cavity cleaning apparatus according to an exemplary embodiment, and FIG. 4 is a side view of an oral cavity cleaning apparatus according to an exemplary embodiment.

The oral cavity cleaning apparatus may be a mouth piece type device so that a user may hold it with his or her teeth. The oral cavity cleaning apparatus may jet a cleaning liquid toward teeth to clean the teeth and the oral cavity.

Vacuum pressure may be formed within the oral cavity cleaning apparatus and a cleaning liquid may be suctioned to allow a strong liquid current to flow, and accordingly, the teeth and gums may be cleaned. Also, the oral cavity cleaning apparatus may include a component for discharging a cleaning liquid including food waste outwardly from the device by vacuum pressure, reduce a phenomenon in which the cleaning liquid splashes out, and simply clean teeth and the oral cavity, without being limited in a usage place. Also, the oral cavity cleaning apparatus may include a component for changing a cleaning liquid jetting direction and a sucking direction, and remove food waste from the teeth and the gums to effectively clean the teeth and the gums.

The oral cavity cleaning apparatus includes a body 100 that a user may hold with his or her teeth, a liquid supply tube 200 connected to the body 100 and supplying a cleaning liquid, and a liquid drain tube 300 discharging a cleaning liquid.

The body 100 may include an insertion slot 110 into which the user's teeth are inserted, and may have a shape similar to a mouth piece on the whole. The body 100 includes a plurality of injection holes 120 formed on an inner wall of the insertion slot 110 adjacent to the side of the body 100 corresponding to an outer surface of the teeth and a plurality of suction holes 130 formed on an inner wall of the insertion slot 110. The liquid supply tube 200 is connected to the body 100 and supplies a cleaning liquid to the injection holes 120 positioned on the inner wall of the insertion slot 110. The liquid drain tube 300 is connected to the body 100 and drains a cleaning liquid within the insertion slot 110 outwardly through the suction hole 130 positioned on the inner wall of the insertion slot 110.

Accordingly, the cleaning liquid jetted through the injection holes 120 may strike pits and fissures of the teeth, the teeth, spaces between the teeth, and the gums to clean the oral cavity. The cleaning liquid pooled in the insertion slot 110 after the oral cavity is cleaned is drained outwardly through the suction holes 130, whereby outward splashing of the cleaning liquid may be reduced, and thus, the oral cavity may be cleaned even in a location such as a hospital room or a living room. Also, since the cleaning liquid is discharged upon completion of cleaning in real time, the cleaning liquid may not be accumulated within the oral cavity of the user, and thus, cleaning of the oral cavity may be continuously performed for an extended period of time.

A supply tube 500 may supply a cleaning liquid to the liquid supply tube 200, and a discharge tube 600 may discharge a cleaning liquid outwardly through the liquid drain tube 300. The liquid supply tube 200 and the liquid drain tube 300 may be detachably connected to the supply tube 500 and the discharge tube 600 by a separate connector 400. In this case, the user may conveniently insert the body 100 into the oral cavity, compared with a case in which the supply tube 500 is fixedly coupled to the liquid supply tube 200 and the discharge tube 600 is fixedly coupled to the liquid drain tube 300, and when the body 100 is replaced, neither the supply tube 500 nor the discharge tube 600 needs to be replaced, reducing maintenance costs.

As illustrated in FIG. 1, the connector 400 includes a first connector 410 installed on an outer end of the liquid supply tube 200 and the liquid drain tube 300 and a second connector 420 detachably coupled to the first connector 410. The supply tube 500 is installed in the second connector 420 in one end thereof to communicate with the liquid supply tube 200, and the discharge tube 600 is installed in the second connector 420 in one end thereof to communicate with the liquid drain tube 300.

When the liquid supply tube 200 and the liquid drain tube 300 are detachably connected to the supply tube 500 and the discharge tube 600, the body 100 may be inserted into the oral cavity and the supply tube 500 and the discharge tube 600 may be subsequently connected, whereby the process of inserting the body 100 into the oral cavity may be easily performed. In addition, since the supply tube 500 and the discharge tube 600 are able to be commonly used, maintenance costs may be reduced.

In order to suction a cleaning liquid to the insertion slot 110 through the supply tube 500 and discharge a cleaning liquid and food waste within the insertion slot 110 outwardly, vacuum pressure may be generated in an internal flow channel of the liquid drain tube 300. To this end, an air compressor (not shown) may be installed in the discharge tube 600 communicating with the liquid drain tube 300. In order to adjust magnitude of vacuum pressure generated within the insertion slot 110 on the basis of pressure by which the user holds the body 100, a pressure sensor (not shown) may be positioned on a bottom surface of the insertion slot 110. The pressure sensor measures pressure by which the user holds the body 100 with his or her teeth, and subsequently generates a corresponding signal. The air compressor may operate to increase or decrease a magnitude of vacuum pressure on the basis of the signal generated by the pressure sensor.

In a case in which the oral cavity cleaning apparatus additionally includes the pressure sensor, the user may freely adjust vacuum suction pressure by adjusting force required for holding the body 100, and thus, the user may more conveniently use the oral cavity cleaning apparatus.

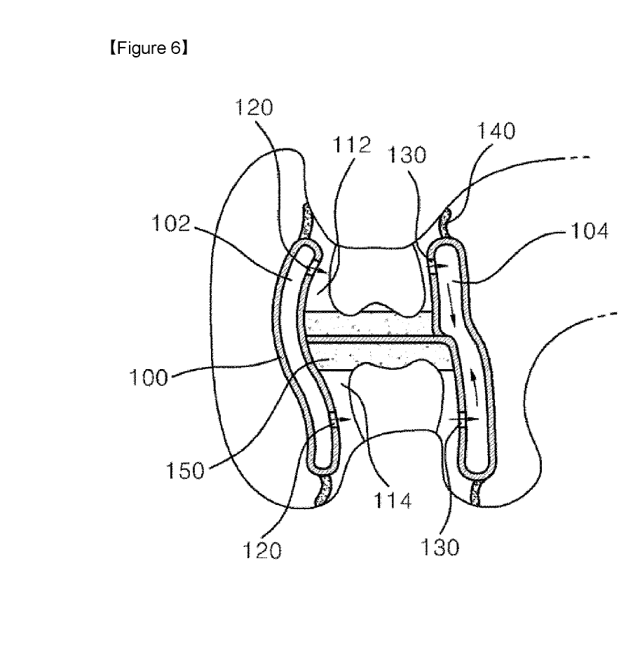

FIG. 5 is a cross-sectional view of a portion of an oral cavity cleaning apparatus according to an exemplary embodiment into which front teeth are inserted, and FIG. 6 is a cross-sectional view of a portion of an oral cavity cleaning apparatus according to an exemplary embodiment into which back teeth are inserted.

Even though vacuum pressure is generated in the suction holes 130, if an internal space of the insertion slot 110 is open with respect to an exterior of the oral cavity cleaning apparatus, it may be difficult to effectively discharge a cleaning liquid and food waste within the insertion slot 110. Thus, in order to reliably generate vacuum pressure within the insertion slot 110, the oral cavity cleaning apparatus may include a sealing member 140 protruding from an edge of an ingress of the insertion slot 110. The sealing member 140 may have a wing shape formed of a material having ductility and elasticity, such as silicon. As illustrated in FIGS. 5 and 6, since an end of the sealing member 140 is tightly attached to the gums of the user, vacuum pressure may be effectively generated in the internal space of the insertion slot 110, and thus, discharge efficiency of a cleaning liquid and food waste within the insertion slot 110 may be enhanced.

Also, when the user holds the body 100 with his or her teeth, if the user holds the body with excessively strong force, his or her teeth may be damaged, so an elastic member 150 may be provided on the bottom surface of the insertion slot 110. The elastic member 150 may be formed of any material as long as the material has elasticity equal to or higher than a reference value in order to protect the user's teeth.

A first internal space 102 communicating with the plurality of injection holes 120 may be formed on the side (the left side in FIGS. 5 and 6) where the injection holes 120 are formed within the body 100, and a second internal space 104 communicating with the plurality of suction holes 130 may be formed on the side (right side in FIGS. 5 and 6) where the suction holes 130 are formed within the body 100. Accordingly, a cleaning liquid supplied through the liquid supply tube 200 may be entirely supplied to the plurality of injection holes 120. Since the liquid supply tube 200 is connected to the first internal space 102 supply a cleaning liquid thereto and the liquid drain tube 300 is connected to form vacuum pressure within the second internal space 104, a cleaning liquid introduced to the first internal space 102 may be jetted through each of the injection holes 120 with uniform pressure and uniform vacuum pressure may be formed in the plurality of suction holes 130 communicating with the first internal space 102.

When the first internal space 102 and the second internal space 104 are prepared within the body 100, a cleaning liquid may be jetted to and suctioned from the front teeth and the back teeth of the user with uniform pressure, whereby the user's teeth and gums may be evenly cleaned on the whole. In a case in which a point at which the liquid supply tube 200 and the first internal space 102 and a point at which the liquid drain tube 300 is connected to the second internal space 104 are set to be relatively close, injection pressure and suction pressure of the cleaning liquid may be concentrated on a region between the liquid supply tube 200 and the liquid drain tube 300, so the point at which the liquid supply tube 200 is connected to the first internal space 102 and the point at which the liquid drain tube 300 is connected to the second internal space 104 are preferably positioned as far from each other as possible. As illustrated in the present exemplary embodiment, when the liquid supply tube 200 is connected to a front side of the first internal space 102 and the liquid drain tube 300 is provide as a pair and connected to the left and right rear sides of the second internal space 104, concentration of injection pressure and suction pressure may be reduced.

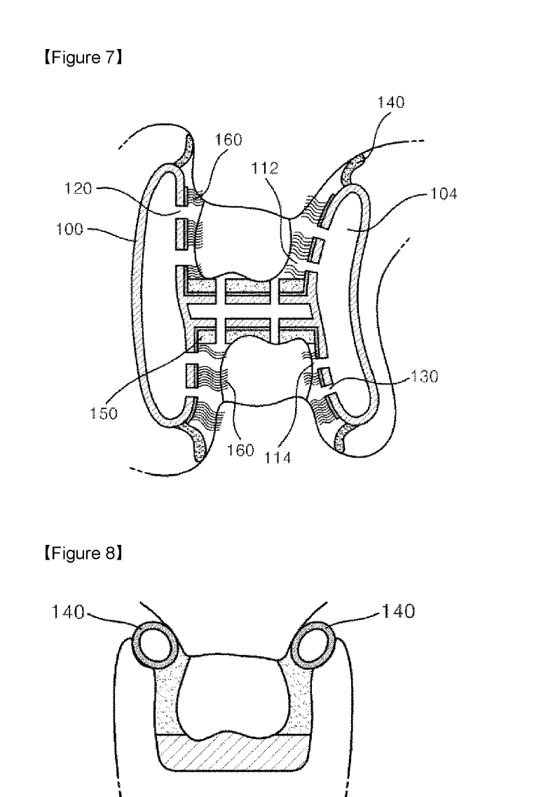

FIG. 7 is a cross-sectional view of a portion of an oral cavity cleaning apparatus according to an exemplary embodiment into which back teeth are inserted.

Positions of the injection holes 120 and the suction holes 130 included in the oral cavity cleaning apparatus may be variously modified according to which portion of the oral cavity is to be concentratedly cleaned or according to characteristics of the user's body.

In the oral cavity cleaning apparatus, as in the exemplary embodiment illustrated in FIGS. 1 to 6, the injection holes 120 are formed on the side of the inner wall of the insertion slot 110 corresponding to an outer surface of teeth, and the suction holes 130 may be formed on the side of the inner wall of the insertion slot 110 corresponding to the inner surface of the teeth, and in this case, an outer surface of the teeth may be concentratedly cleaned. Conversely, the injection holes 120 may be formed on the side of the inner wall of the insertion slot 110 corresponding to the inner surface of the teeth and the suction holes 130 may be formed on the side of the inner wall of the insertion slot 110 corresponding to the inner surface of the teeth, and in this case, the inner surface of the teeth may be concentratedly cleaned.

In addition, as illustrated in FIG. 7, the injection holes 120 may be formed on the side of the inner wall of the insertion slot 110 corresponding to the outer surface of the teeth and on the side of the inner wall of the insertion slot 110 corresponding to the inner surface of the teeth, and the suction holes 130 may be formed on a bottom surface of the insertion slot 110. In this case, both outer surfaces and inner surfaces of the teeth may be cleaned.

The oral cavity cleaning apparatus may only perform cleaning with cleaning liquid at high pressure jetted through the injection holes 120 or may additionally clean the teeth and the gums through a separate flow member 160. A plurality of flow members 160 may be positioned on an inner wall of the insertion slot 110, extend toward the user's teeth, and move according to a flow of a liquid current. For example, the flow member 160 may have a fibrous shape and may be formed of an organic material, an inorganic material, or a composite organic and inorganic material.

When the flow member 160 is additionally provided, when a cleaning liquid is injected through the injection holes 120 at high pressure, the flow member 160 may be moved by the cleaning liquid injection pressure, and accordingly, the flow member 160 may be brought into frictional contact with the user's teeth and gums. Since the flow member 160 massages the user's teeth and gums, oral cavity cleaning may be further enhanced.

FIG. 8 is a partial cross-sectional view of a portion of an oral cavity cleaning apparatus according to an exemplary embodiment into which back teeth are inserted.

The sealing member 140 may be manufactured to have a wing shape with a small thickness as illustrated in FIGS. 1 to 7, or may be formed to have a tube shape as illustrated in FIG. 8. The sealing member 140 may form stable and effective vacuum pressure within the insertion slot 110.

When the sealing member 140 has a tube shape, a contact area between the sealing member 140 and the gums may be increased to obtain a better seal. The sealing member 140 may be formed of a soft material which does not press the gum tissue of the user and is smoothly deformed according to the shape of the gums, and thus, the user may not feel pain.

In FIG. 8, a case in which the sealing member 140 is formed to have a hollow tube shape is illustrated, but the sealing member 140 may be formed to have a solid bar shape.

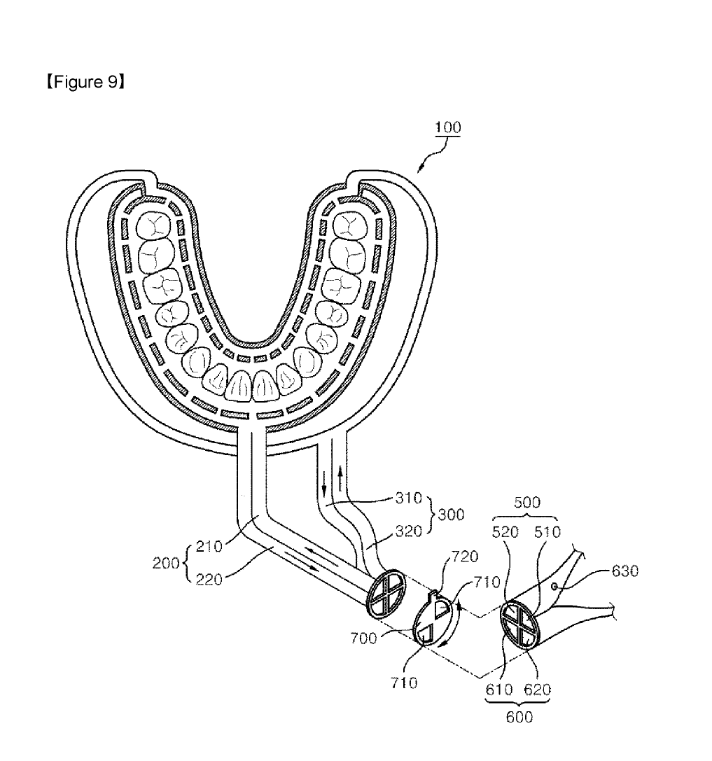

FIG. 9 is a schematic view of an oral cavity cleaning apparatus according to an exemplary embodiment.

In the oral cavity cleaning apparatus, a cleaning liquid injection direction and a cleaning liquid suction direction may be switched. Switching of the cleaning liquid injection direction and the cleaning liquid suction direction may be performed automatically or manually.

The liquid supply tube 200 may be divided into a first liquid supply tube 210 and a second liquid supply tube 220 communicating with the first internal space 102. In the liquid supply tube 200, the first liquid supply tube 210 and the second liquid supply tube 220 may be divided only in the vicinity of a switching member 700 and may not be divided but communicate with each other in the other remaining section of the liquid supply tube 200.

The liquid drain tube 300 may be divided into a first liquid drain tube 310 and a second liquid drain tube 320 communicating with the second internal space 104. In the liquid drain tube 300, the first liquid drain tube 310 and the second liquid drain tube 320 may be divided only in the vicinity of the switching member 700 and may not be divided but communicate with each other in the other remaining section of the liquid drain tube 300.

The supply tube 500 may be divided into a first supply tube 510 communicating with the first liquid supply tube 210 and a second supply tube 520 communicating with the second liquid drain tube 320. The discharge tube 600 may be divided into a first discharge tube 610 communicating with the first drain tube 310 and a second discharge tube 620 communicating with the second liquid supply tube 220. Also, the first liquid supply tube 210 and the second liquid supply tube 220 are arranged to be adjacent to each other in a vertical direction, the first liquid drain tube 310 and the second liquid drain tube 320 may be arranged to be adjacent to each other in a vertical direction, the first liquid drain tube 310 is coupled to one side of the second liquid supply tube 220, and the second liquid drain tube 320 is coupled to one side of the first liquid supply tube 210, forming a structure in which a single large tube is divided into four sections as illustrated in FIG. 9.

The oral cavity cleaning apparatus may further include the switching member 700. The switching member 700 may be installed between the liquid supply tube 200 and the liquid drain tube 300, respectively, and the supply tube 500 and the discharge tube 600, respectively, and switch a direction of a cleaning liquid flowing in the liquid supply tube 200 and the liquid drain tube 300. For example, the switching member 700 may selectively open and close the liquid supply tube 200 and the liquid drain tube 300. Alternatively, the switching member 700 may move a suction member in such a manner that the suction member is connected to any one of the liquid supply tube 200 and the liquid drain tube 300. The switching member 700 is rotatably installed and may have a pair of flow path holes 710 in points facing each other around a rotational axis. According to rotation angles of the switching member 700, the first liquid supply tube 210 and the first liquid drain tube 310 are opened, while the second liquid supply tube 220 and the second liquid drain tube 320 are closed, or the first liquid supply tube 210 and the first liquid drain tube 310 are closed, while the second liquid supply tube 220 and the second liquid drain tube 320 are opened.

For example, in a case in which a cleaning liquid is supplied and vacuum pressure is generated in a state in which the flow path holes 710 of the switching member 700 are rotated to be matched to the first liquid supply pipe 210 and the first liquid drain pipe 310, vacuum pressure generated in the discharge tube 600 may be transmitted to the first liquid drain tube 310 and the second internal space 104 and a cleaning liquid provided through the supply pipe 500 may be introduced to the first liquid supply tube 210. Accordingly, the cleaning liquid may be jetted to the teeth through the injection holes 120 and the cleaning liquid filling the interior of the insertion slot 110 may be suctioned through the suction holes 130 and subsequently discharged outwardly. A cleaning liquid may be jetted and discharged in the same manner as that of the exemplary embodiment illustrated in FIGS. 1 to 6.

In a case in which the switching member 700 rotates by 90 degrees so the flow path holes 710 of the switching member 700 are positioned to be matched to the second liquid supply tube 220 and the second liquid drain tube 320 as illustrated in FIG. 9, vacuum pressure generated in the discharge pipe 600 may be transmitted to the second liquid supply tube 220 and the first internal space 102 and a cleaning liquid provided through the supply pipe 500 may be introduced to the second liquid drain tube 320 and the second internal space 104. Accordingly, the cleaning liquid may be jetted to the teeth through the suction holes 130 and the cleaning liquid filling the interior of the insertion slot 110 may be suctioned through the injection holes 120 and subsequently discharged outwardly. In comparison to the exemplary embodiment illustrated in FIGS. 1 to 6, the cleaning liquid flows in the opposite direction.

Compared with the exemplary embodiment illustrated in FIGS. 1 to 6 in which the cleaning liquid may only clean the outer surfaces of the teeth, in the present exemplary embodiment, since the cleaning liquid may be controlled to flow in a forward direction or backward direction by operating the switching member 700, both outer and inner surfaces of the teeth may be cleaned.

The switching member 700 may be modified to have various other shapes, without being limited to the disk shape. The switching member 700 may include four valves independently opening and closing the first liquid supply tube 210, the second liquid supply tube 220, the first liquid drain tube 310, and the second liquid drain tube 320. Also, a cleaning liquid supply path and a vacuum pressure generation path may be adjusted, even without the switching member 700, by independently controlling the first supply tube 210, the second supply tube 520, the first discharge tube 610, and the second discharge tube 520.

A gas injection hole 630 for injecting a gas into an inner flow channel may be provided on the supply pipe 500 to generate bubbles to be included in the cleaning liquid supplied to the liquid supply tube 200. When the cleaning liquid including bubbles is supplied to the liquid supply tube 200 and jetted to the teeth and the gums, bubbles may collide with the teeth and the gums, enhancing cleaning power.

A gas introduced to the air injection hole 630 may be air or may be a gas including a component for enhancing cleaning power. Also, a gas may be injected through the gas injection hole 630 according to pressure difference made by a flow rate of the cleaning liquid within the supply pipe 500 or may be forcibly injected by a separate gas injection device (not shown).

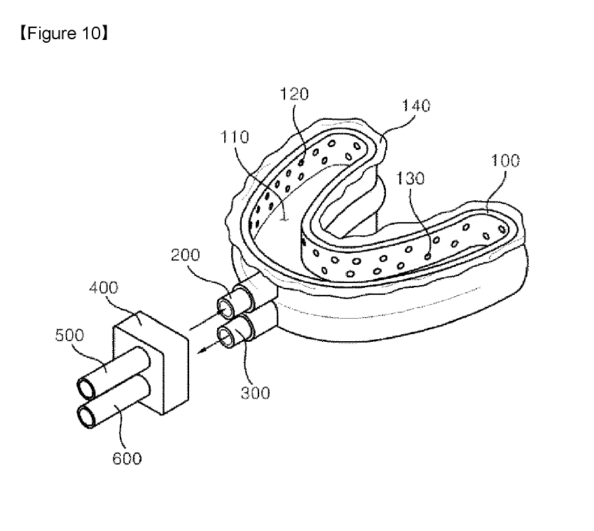

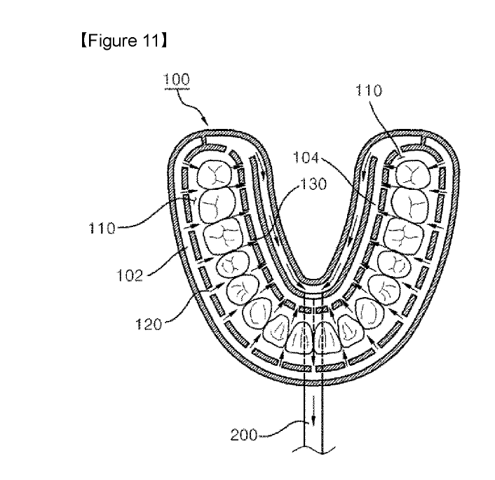

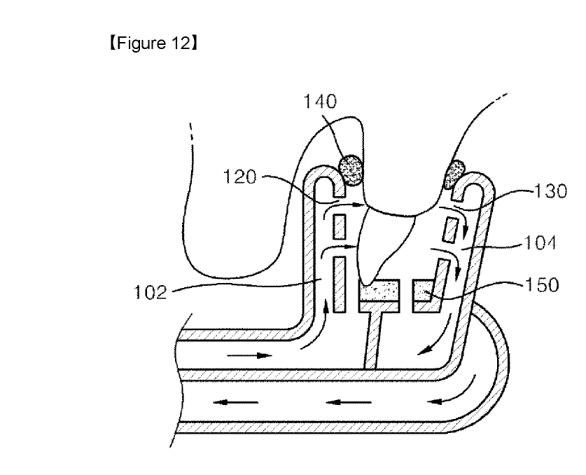

FIG. 10 is a perspective view of an oral cavity cleaning apparatus according to an exemplary embodiment, FIG. 11 is a plan cross-sectional view of an oral cavity cleaning apparatus according to an exemplary embodiment, and FIG. 12 is a cross-sectional view of a dead central portion of an oral cavity cleaning apparatus according to an exemplary embodiment into which front teeth are inserted.

As illustrated in FIGS. 1 to 6, the oral cavity cleaning apparatus may be configured to individually include an upper insertion slot 112 into which the user's upper teeth are inserted and a lower insertion slot 114 into which the user's lower teeth are inserted so that the upper teeth and the lower teeth may be cleaned separately. Alternatively, as illustrated in FIGS. 10 to 12, the insertion slot 110 may only be provided in an upper portion of the body 100 so that only the upper teeth may be inserted thereinto or the insertion slot 110 may only be formed in a lower portion of the body 100 so that only the lower teeth may be inserted thereinto.

When the insertion slot 110 is only formed in the upper portion of the body 100, the user may selectively clean only the upper teeth and the lower teeth, increasing utilization, and since an overall thickness of the body 100 is reduced, even a person who has a lower jaw with a small rotation angle may easily insert the body 100 into the oral cavity, the user may conveniently use the oral cavity cleaning apparatus.

Also, when the insertion slot 110 is formed on upper and lower surfaces of the body 100, the liquid drain tube 300 is inevitably arranged on the side of the body 100 as illustrated in FIG. 1, increasing an overall width of the body 100 and thus making it difficult for a user with a small mouth to insert the body 100 into the oral cavity. In contrast, when the insertion slot 110 is only formed on the upper surface of the body 100, the liquid drain tube 300 may be arranged below the body 100 as illustrated in FIG. 12, reducing an overall width of the body 100, and thus, even a person with a small mouth may easily insert the body 100 into the oral cavity.

While exemplary embodiments have been shown and described above, it will be apparent to those skilled in the art that modifications and variations could be made without departing from the scope of the present disclosure as defined by the appended claims.

1. An oral cavity cleaning apparatus comprising:
a body including an insertion slot into which a user's teeth are inserted and a plurality of injection holes and a plurality of suction holes positioned in an inner wall of the insertion slot; a liquid supply tube supplying a cleaning liquid through the plurality of injection holes; a liquid drain tube discharging the cleaning liquid outwardly through the plurality of suction holes; and a switching member switching an injection direction and a suction direction of the cleaning liquid, wherein the body includes a first internal space communicating with the plurality of injection holes and a second internal space communicating with the plurality of suction holes.

2. The oral cavity cleaning apparatus of claim 1, further comprising a sealing member protruding from an edge of an ingress of the insertion slot and tightly attached to the user's gums.

3. The oral cavity cleaning apparatus of claim 1, wherein the liquid supply tube includes a first liquid supply tube and a second liquid supply tube, the liquid drain tube includes a first liquid drain tube and a second liquid drain tube, and the switching member selectively opens and closes the first liquid supply tube and the first liquid drain tube or the second liquid supply tube and the second liquid drain tube.

4. The oral cavity cleaning apparatus of claim 3, wherein the switching member is positioned between the liquid supply tube and the liquid drain tube, respectively, and a supply tube and a discharge tube, respectively, and opens the first liquid supply tube and the first liquid drain tube, and closes the second liquid supply tube and the second liquid drain tube, or opens the second liquid supply tube and the second liquid drain tube, and closes the first liquid supply tube and the first liquid drain tube.

5. The oral cavity cleaning apparatus of claim 4, wherein the switching member rotates centered on a rotational axis thereof and has a pair of flow path holes provided in locations facing each other while being centered on the rotational axis to open the first liquid supply tube and the first liquid drain tube and close the second liquid supply tube and the second liquid drain tube or to open the second liquid supply tube and the second liquid drain tube and close the first liquid supply tube and the first liquid drain tube.

6. The oral cavity cleaning apparatus of claim 1, wherein the plurality of injection holes are positioned in any one of the side of an inner wall of the insertion slot corresponding to an outer surface of teeth and the side of the inner wall of the insertion slot corresponding to an inner surface of the teeth, and the plurality of suction holes are positioned in the other of the side of the inner wall of the insertion slot corresponding to the outer surface of the teeth and the side of the inner wall of the insertion slot corresponding to the inner surface of the teeth.

7. The oral cavity cleaning apparatus of claim 1, wherein the plurality of injection holes are positioned in the side of the inner wall of the insertion slot corresponding to the outer surface of the teeth and on the side of the inner wall of the insertion slot corresponding to the inner surface of the teeth, and the plurality of suction holes are positioned in a bottom surface of the insertion slot.

8. The oral cavity cleaning apparatus of claim 1, wherein the oral cavity cleaning apparatus further includes an elastic member positioned on the bottom surface of the insertion slot.

9. The oral cavity cleaning apparatus of claim 1, further comprising a first connector installed at an outer end of each of the liquid supply tube and the liquid drain tube; a second connector detachably coupled to the first connector; a supply tube installed in the second connector in one end thereof and communicating with the liquid supply tube; and a discharge tube installed in the second connector in one end thereof and communicating with the liquid drain tube.

10. The oral cavity cleaning apparatus of claim 1, wherein the cleaning liquid supplied through the liquid supply tube includes bubbles.

11. The oral cavity cleaning apparatus of claim 1, further comprising a plurality of flow members attached to an inner wall of the insertion slot and extending toward the user's teeth.

12. The oral cavity cleaning apparatus of claim 1, wherein the insertion slot includes an upper insertion slot into which the user's upper teeth are inserted and a lower insertion slot into which the user's lower teeth are inserted.

13. The oral cavity cleaning apparatus of claim 1, further comprising a pressure sensor installed on a bottom surface of the insertion slot, measuring an amount of pressure by which the user holds the body and generating a corresponding signal, and an air compressor generating vacuum pressure in an internal flow channel of the liquid drain tube and increasing or decreasing a magnitude of the vacuum pressure according to the signal generated by the pressure sensor.
